(19) United States
(12) Patent Application Publication
(10) Pub. No.: US 2015/0186343 A1
(43) Pub. Date: Jul. 2, 2015

(54) METHOD AND SYSTEM FOR PROVIDING CONTENT SEGMENTS OF AN INTERACTIVE MEDIA EXPERIENCE AS WEBPAGES

(71) Applicant: RAPT MEDIA, INC., Boulder, CO (US)

(72) Inventors: Brannan Patrick McGill, Colorado Springs, CO (US); Justin Tucker Trautman, Morrison, CO (US)

(21) Appl. No.: 14/146,625

(22) Filed: Jan. 2, 2014

(51) Int. Cl. G06F 17/22; G06F 3/0481

(52) U.S. Cl. CPC G06F 17/2247; G06F 3/0481

(57) ABSTRACT

Methods, apparatuses, and systems are disclosed for providing content segments of an interactive media experience as webpages. One example server apparatus includes a content storage module storing at least one interactive media experience, the interactive media experience including a plurality of content segments. The server apparatus also includes a communications module configured to provide a plurality of respective webpages corresponding to respective ones of the plurality of content segments of the at least one interactive media experience, each respective webpage including one or more links to others of the plurality of respective webpages.

### TECHNICAL FIELD

This disclosure relates generally to media content distribution, and more particularly to methods and systems for providing content segments of an interactive media experience as webpages.

### BACKGROUND

The use of media content distributed through the Internet has increased dramatically since the origins of text-only webpages. Conventionally, however, most media content is seen as a closed box for indexing functions, such as when search engines “crawl” a website to populate a database that can be quickly searched. As one example, a webpage that has a video embedded on it typically includes a small amount of metadata associated with the video such as the title of the video and a few keywords. An indexer can see and understand the metadata, but typically cannot parse the video content itself. This arrangement has been tolerated largely because most media content presented over the internet is static in that there is little to no participant interaction with the media content. Participants can start and stop or skip forward and backward through certain media (e.g., a video or audio clip embedded on a webpage), but the results of this type of action is fairly irrelevant to an indexer.

Newer content distribution mechanisms, such as Adobe® Flash®, allow more sophisticated participant interaction with media content. Many of these mechanisms, however, provide an indexer with little or no information about what types of interactions are permissible, and what results arise out of different interactions. As a result, indexers may glean inadequate or no information from websites that host the content, which may in turn lead to inadequate searching of the website, inadequate traffic redirected from search engines, and so forth.

### BRIEF DESCRIPTION OF THE DRAWINGS

FIG. 1 is a block diagram of a system for providing content segments of an interactive media experience as webpages.

FIG. 2 is a plot structure diagram for an interactive media experience.

FIGS. 3A through 3C illustrate conceptual outlines for the structure of webpages for providing content segments of an interactive media experience as webpages.

FIG. 4 is a simplified listing of HTML code for a main webpage for use in the present disclosure.

FIGS. 5A through 5C are simplified listings of HTML code for individual nodes corresponding to individual content segments of an interactive media experience.

FIG. 6 is a simplified screenshot from a computer display providing a content segment of an interactive media experience to a participant.

### DETAILED DESCRIPTION

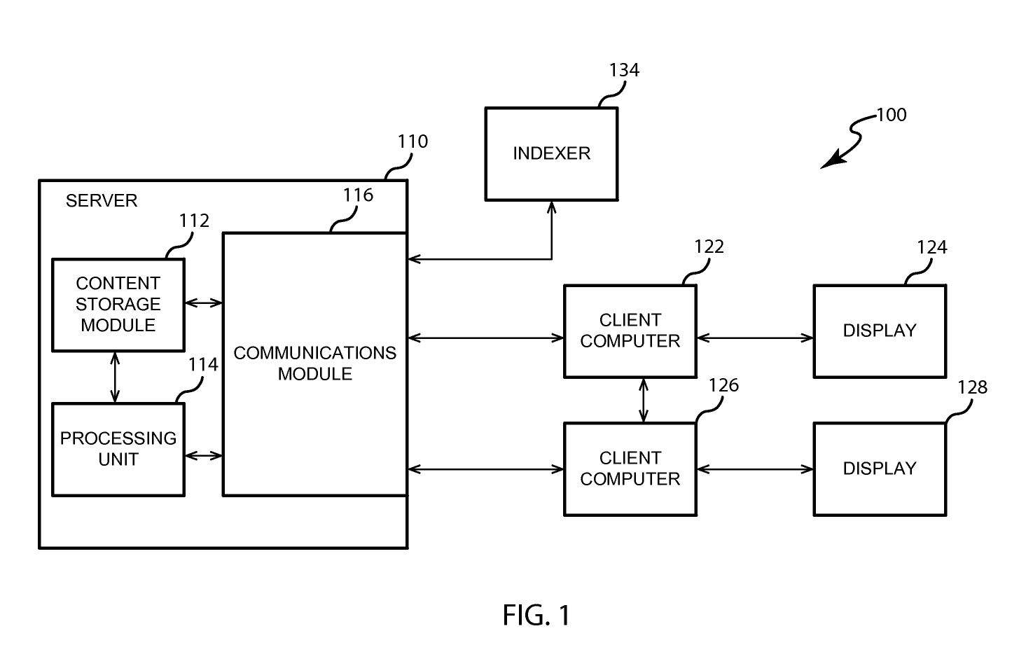

FIG. 1 illustrates a system 100 for providing content segments of an interactive media experience as webpages. The system 100 includes a server 110 that is configured to be communicatively coupled to a plurality of client computers 122, 126, 134. The server 110 may receive requests from the client computers 122, 126, 134, and provide responses thereto, including by providing hosted content from the content storage module 112 described below.

The server 110 may be any type of Internet server that is configured to receive requests and provide Internet content in response. The client computers 122, 126, 134 may be any type of computer, such as a laptop computer, a desktop computer, a tablet computer, a mobile computer, a cellular telephone, a smart phone, a personal digital assistant, a digital media player, and/or any electronic device. In some embodiments, one or more of the client computers 122, 126, 134 may not have a certain content distribution platform, such as Adobe® Flash®. At least some of the client computers 122, 126 may include a respective display device 124, 128, such as a computer monitor, integrated LCD/LED display, and so forth. The client computers 122, 126, 134 may also include a processor configured to send requests to and receive responses from the server 110. One of the client computers may be an indexer 134 such as a web search engine crawler, a web archive service, an analytics tool, an accessibility tool (e.g., to help a visually impaired person interpret a webpage in a non-visual manner), and so forth.

The server 110 includes a content storage module 112, a processing unit 114, and a communications module 116, which may all be communicatively coupled to one another. The content storage module 112 may take the form of a magnetic storage medium, an optical storage medium, a magneto-optical storage medium, read only memory, random access memory, erasable programmable memory, flash memory, and so on. The content storage module 112 is configured to store one or more interactive media experiences. Each interactive media experience may be structured as a plurality of nodes, with each node associated with one of a plurality of content segments of an interactive media experience, a webpage, a unique webpage address, and one or more links to others of the plurality of nodes and associated content segments. The webpage associated with each node may be defined by computer code, such as HyperText Markup Language (HTML), which controls the presentation of the webpage to a participant, including the presentation of various elements (text, audio, video, image, etc.) via a web browser on a display screen, the functions the participant can take on the webpage, links to other webpages, and so forth. The unique webpage address associated with each node may be a Uniform Resource Identifier (URI), which a participant can enter into a web browser in order to gain access to the respective node of the interactive media experience and its respective content segment via the webpage associated with the unique webpage address entered by the participant.

Each content segment may include one or more videos, images, audio clips, games, and so forth. For example, an interactive video experience may include a plurality of video subsections, with each of the plurality of video subsections corresponding to one of the plurality of content segments of the interactive media experience. In another example, the interactive experience may include a slideshow of images, with each of the images in the slideshow corresponding to one of the plurality of segments of the interactive media experience.

The interactive media experience may, for example, be as described in U.S. patent application Ser. No. 13/274,224, filed on Oct. 14, 2011, and entitled “WEB-BASED INTERACTIVE GAME UTILIZING VIDEO COMPONENTS,” and/or as described in U.S. patent application Ser. No. 13/935,014, filed on Jul. 3, 2013, and entitled “VIDEO FRAME STILL IMAGE SEQUENCES,” both of which are hereby incorporated by reference in their respective entireties.

Furthermore, the plurality of content segments need not be all the same type of content—for example, the interactive media experience may include some videos, some images, and some audio clips. The unique webpage address associated with each of the plurality of content segments may provide a mechanism by which a participant can access respective ones of the plurality of content segments.

The processing unit 114 of the server 110 may be operable to execute one or more instructions related to the content segments of the one or more interactive media experiences stored in the content storage module 112. In some embodiments, the processing unit 114 may be coupled between the content storage module 112 and the communications module 116 and may provide content segments of an interactive media experience from the content storage module 112 to the communications module 116. In other embodiments, the content storage module 112 may communicate with and provide content segments directly to the communications module 116.

The communications module 116 is configured to provide a plurality of respective webpages (and respective content segments), corresponding to respective ones of the plurality of nodes of the interactive media experience, to the client computers 122, 126, 134. In general, the webpages may be provided to any computing device that requests the webpages from the server 110. The communications module 116 may also provide other webpages that do not necessarily correspond to respective ones of the plurality of nodes of the interactive media experience—for example, the communications module 116 may also provide log-in and administrative webpages. When a participant sends a request with a respective, unique webpage address to the server 110, the server 110 may respond by providing the HTML code related to the corresponding webpage.

At least some of the respective webpages provided by the communications module 116—in particular those that correspond with the nodes of the interactive experience—may include one or more links to the unique webpage addresses associated with others of the plurality of respective webpages and corresponding content segments. The one or more links may be provided such that upon selection of one of the links in a first of the plurality of webpages corresponding to a first of the plurality of segments of the interactive media experience, the computer server 110 retrieves a second of the plurality of webpages and its corresponding second segment of the interactive media experience to provide to the participant. In other words, the one or more links may be provided in a manner to enable a participant of the interactive media experience to navigate through the various nodes of the interactive media experience by clicking on buttons or other elements corresponding to the one or more links in each respective webpage corresponding to the nodes of the interactive media experience.

The one or more links may also be provided in a manner to permit an indexer 134 to crawl through all of the plurality of respective webpages by following the one or more links in each of the plurality of respective webpages. Thus, in addition to the links providing the functionality for a human participant to enjoy the interactive media experience, the one or more links also allow a computer to understand what types of interactions are permissible for each node (and at what point within the node), as well as what would happen should a human participant interact with the node in a certain way. In other words, the one or more links in the respective webpages provide structural information of the interactive media experience that allows the indexer 134 to simulate the “interactive” actions of a participant in order to index all of the webpages corresponding to the interactive media experience. In some examples, as mentioned above, an analytics tool may make use of the one or more links in each of the plurality of respective webpages. For example, the one or more links may allow an analytics tools to track a user through the interactive media experience, which tracking may not be possible with other content distribution platforms (e.g., web browser plug-in applications) that do not have links to other nodes and associated webpages.

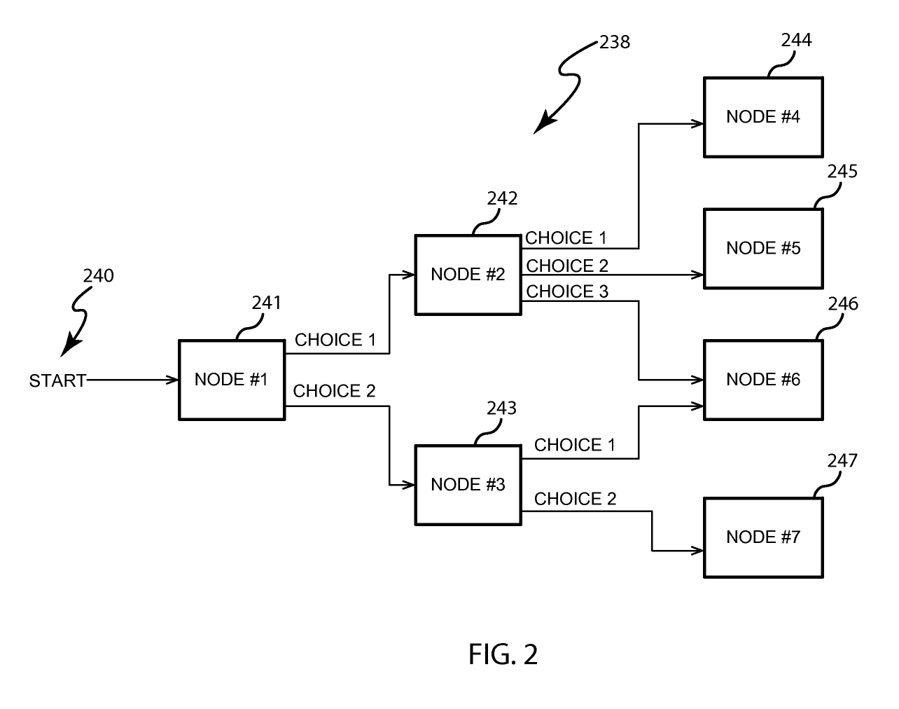

With reference now to FIG. 2, a plot structure diagram 238 for one example of an interactive media experience that may be hosted by the server 110 in FIG. 1 is shown. The interactive media experience illustrated in FIG. 2 begins at a starting point 240, and proceeds to a first node 241. The first node 241 corresponds to a first content segment of the interactive media experience, such as a video subsection, an image, a sound clip, etc. A first webpage, accessible via a first unique webpage address, is also associated with the first content segment of the first node 241—for example, the first webpage may include HTML code that defines where, when, and how large the content segment should be displayed on a display device of a client computer that has requested the first node 241. As described above, the server 110, upon a participant entering the first unique webpage address for the first node 241, or clicking on a link thereto, and requesting the same from the server 110, the communications module 116 of the server 110 may provide the first webpage, along with the first content segment, to the participant's client computer and associated display for consumption of the interactive media experience.

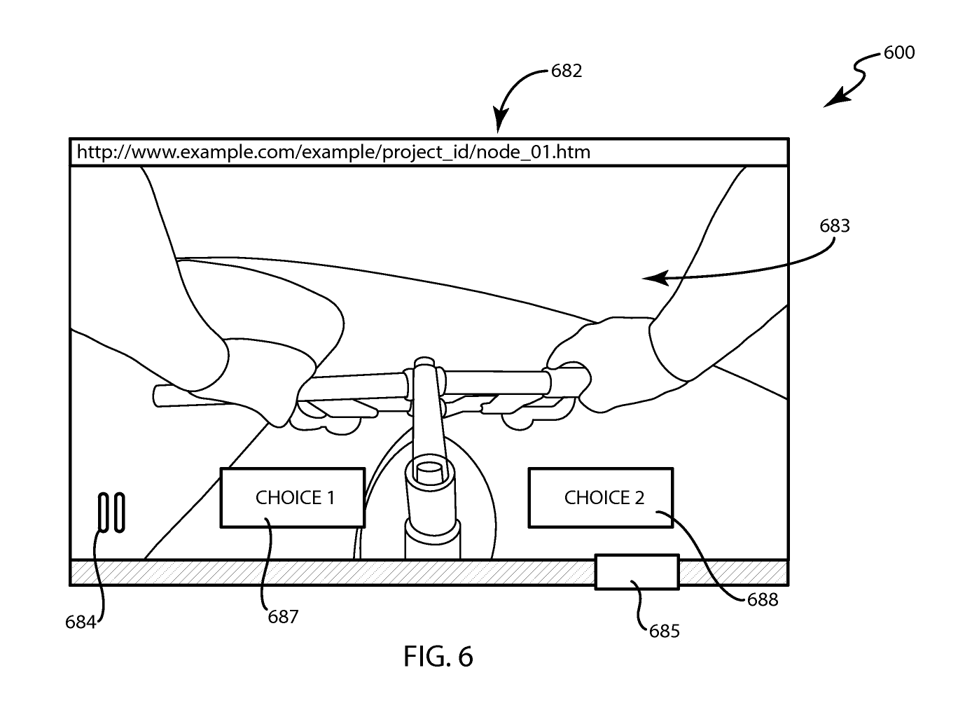

As illustrated in FIG. 2, the first node 241 includes a branch point, leading to second and third nodes 242, 243 via either CHOICE 1 or CHOICE 2. The branch point may correspond with a decision to be made during, at the end of, or after the first content segment of the interactive media experience, with CHOICE 1 and CHOICE 2 corresponding to possible options that a participant may select. The CHOICE 1 and CHOICE 2 options may be presented to a participant during, at the end of, or after the presentation of the first content segment corresponding to the first node 241 (see description of FIG. 6 below) as a result of links present in the webpage corresponding to the first node 241. In other words, the webpage corresponding to the first node 241 may include one or more links to other nodes of the interactive media experience, and a participant who selects one of the one or more links to other nodes may do so in response to branch point in the first content segment.

If, for example, the first content segment associated with the first node 241 is a video subsection, at some point during, at the end of, or after presentation of the video subsection, the participant may be presented with two different paths for a character to take, with the subsequently provided content segment depending on which option the participant selects. If the participant selects CHOICE 1, the subsequent content segment provided to the participant may be a second content segment corresponding to second node 242, whereas if the participant selects CHOICE 2, the subsequent content segment provided to the participant may be a third content segment corresponding to third node 243.

As illustrated in the example plot structure diagram 238 in FIG. 2, the second node 242 also includes a branch point leading to fourth, fifth, and sixth nodes 244, 245, 246 via either CHOICE 1, CHOICE 2, or CHOICE 3, respectively. Also, the third node 243 includes a branch point leading to either the sixth node 246 or a seventh node 247. It will be understood that the example plot structure diagram 238 in FIG. 2 is merely one example of a plot structure diagram, and that many other types of diagrams and many other plot formats may be used.

With reference to FIG. 2, because each of the nodes 241, 242, 243, 244, 245, 246, 247 of the interactive media experience has a corresponding unique webpage address, it will be appreciated that a participant may “enter” the interactive media experience at many different entry points—specifically, the participant may enter at any of the nodes 241, 242, 243, 244, 245, 246, 247 of the interactive media experience. For example, if a first participant receives a specific link from a second participant (e.g., over a connection between client computers 122, 126), with the link corresponding to the third node 243, upon the first participant requesting content corresponding to that specific link, the server 110 may provide the webpage and third content segment corresponding to the third node 243 without the first participant needing to pass through the first node 241 and its associated content segment.

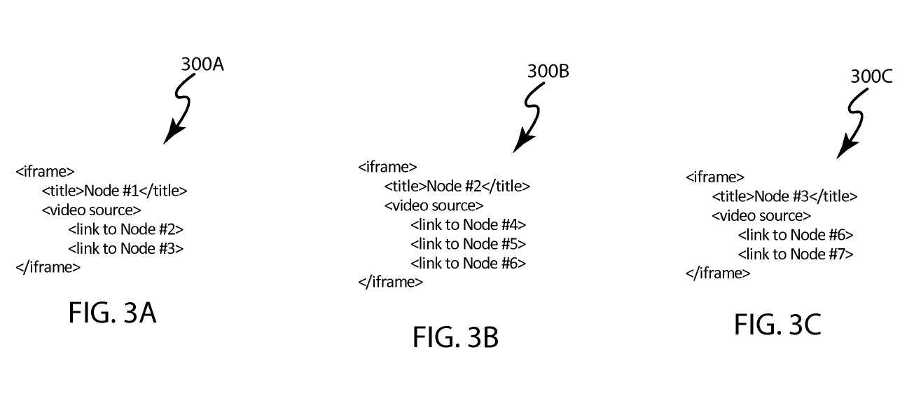

Turning now to FIGS. 3A through 3C, conceptual outlines 300A, 300B, 300C for the structure of webpages corresponding to the first, second, and third nodes 241, 242, 243 in FIG. 2 are illustrated. In FIG. 3A, a conceptual outline 300A of code for a webpage corresponding to the first node 241 is shown, including a tag referencing a video source for the first content segment, and tags referencing links to second and third nodes 242, 243. In FIG. 3B, a conceptual outline 300B of code for a webpage corresponding to the second node 242 is shown, including a tag referencing a video source for the second content segment, and tags referencing links to fourth, fifth, and sixth nodes 244, 245, 246. In FIG. 3C, a conceptual outline 300C of code for a webpage corresponding to the third node 243 is shown, including a tag referencing a video source for the third content segment, and tags referencing links to sixth and seventh nodes 246, 247.

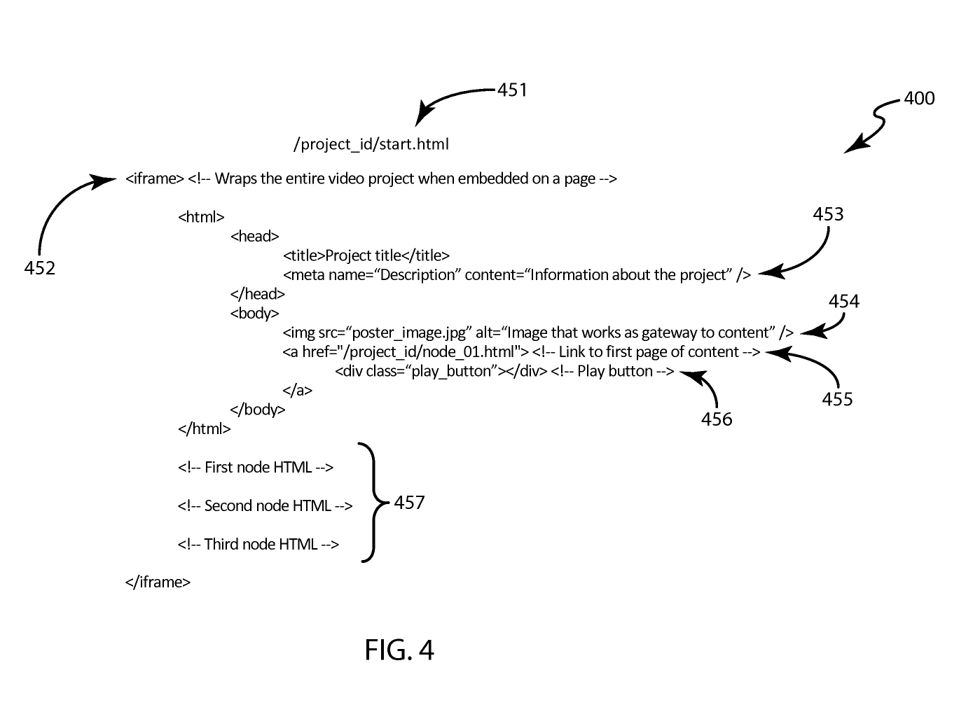

FIG. 4 illustrates a simplified listing 400 of HTML code for a main webpage—for example, a webpage corresponding to starting point 240 of the plot structure diagram 238 in FIG. 2. The main webpage may have an address 451 of/project_id/start.html, as illustrated in FIG. 4. The main webpage may include a tag defining an inline frame (iframe) element 452. The inline frame element defined by one webpage provides an area on the display of that first webpage in which a second webpage can be displayed—in other words, the first webpage provides a “frame,” with the “frame” being filled with the substantive content of the second webpage. In this format, the “framed” webpage can be swapped out without changing the “frame,” thus providing a more seamless experience to a participant of the interactive media experience as the “framed” content is changed out during an interactive video experience. The functionality of the inline frame can also allow for one or more features (such as an audio track) to be persistently provided to a participant—outside of the inline frame—contemporaneous with multiple different “framed” webpages being swapped out, without any disruption to the persistent feature.

Within the inline frame element 452, the main webpage includes a tag for a header 453 with some metadata. The main webpage also includes a tag for a gateway image 454. Tags for a link 455 to the first node 441 of the interactive media experience and for a corresponding input button 456 are also shown in FIG. 4. In some examples, and as shown in FIG. 4, HTML code 457 corresponding to the first, second, and third nodes 241, 242, 243 may also be included within the inline frame element 452. In these examples, the upon selection of the link 455 to the first node 241, the HTML code corresponding to the first node 241 may be interpreted by the web browser and displayed in the inline frame element. In other examples, the HTML code corresponding to the first and other nodes may need to be separately requested from server 110 before the associated web content can be displayed to a participant.

It should be noted that while FIG. 4 illustrates an example listing of HTML code defining an inline frame element, in other embodiments of the present disclosure, inline frame elements need not be used. Instead, a new webpage, at a new unique webpage address, may be fetched responsive to a participant selecting an option at a branch point. Or, in still another example, the HTML (or other) code can be dynamically built within whatever is the current node's HTML structure, or adjacent to the current node's structure.

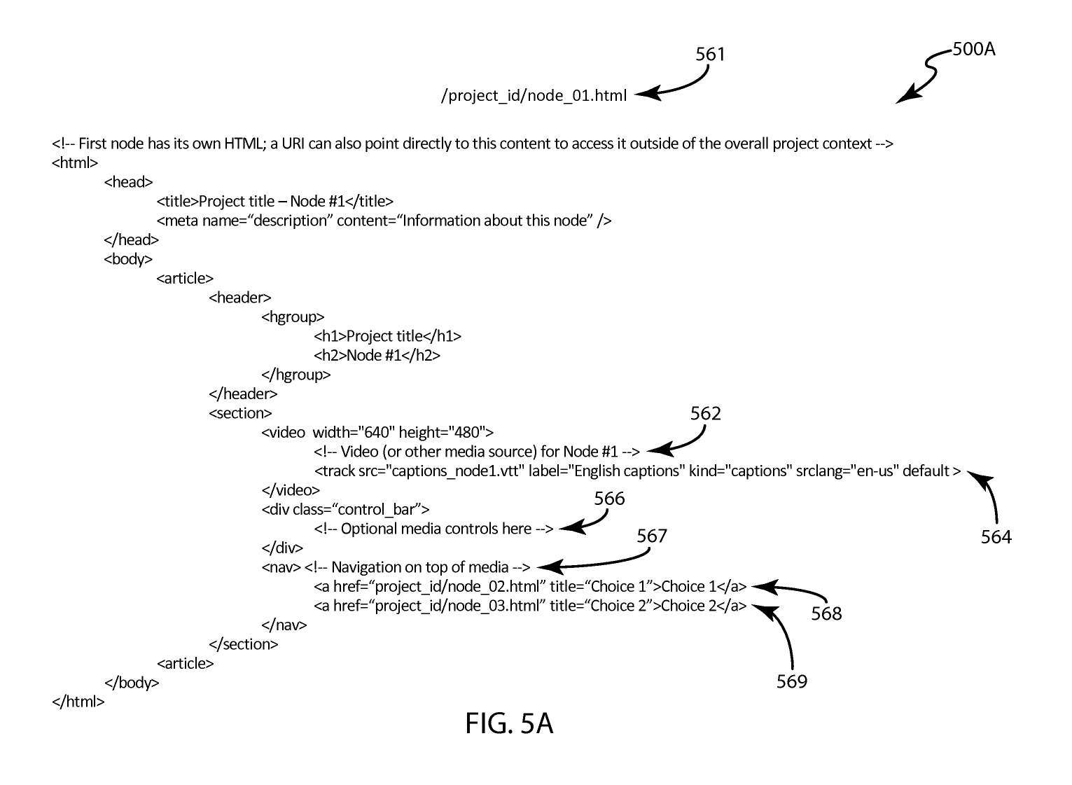

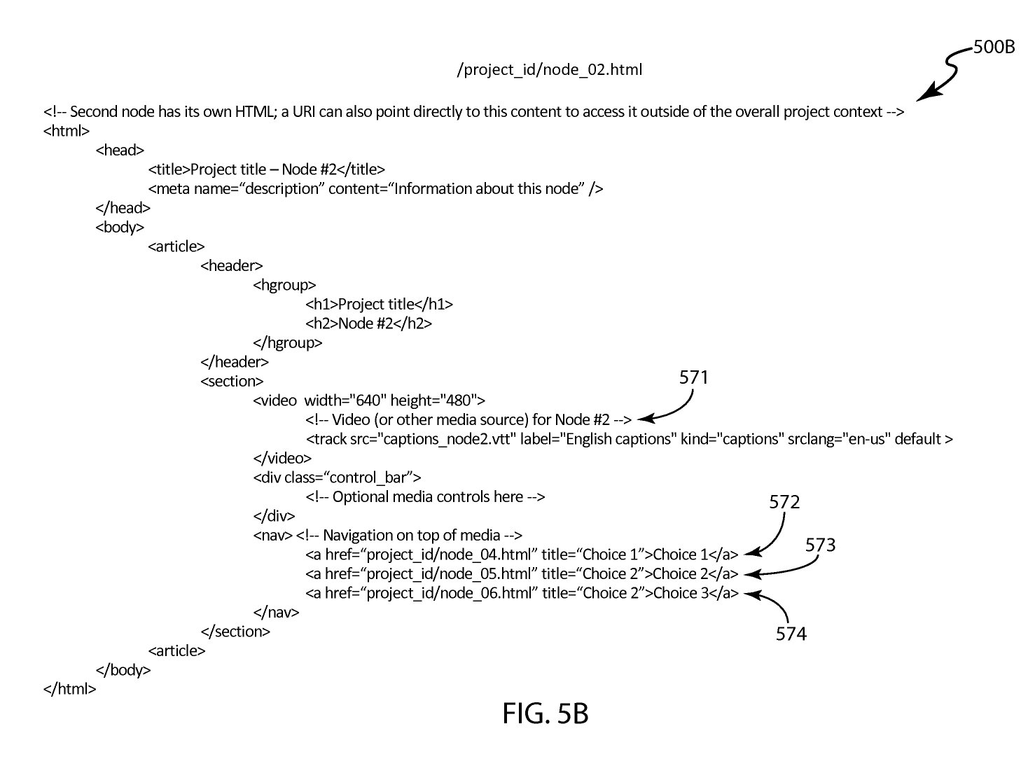

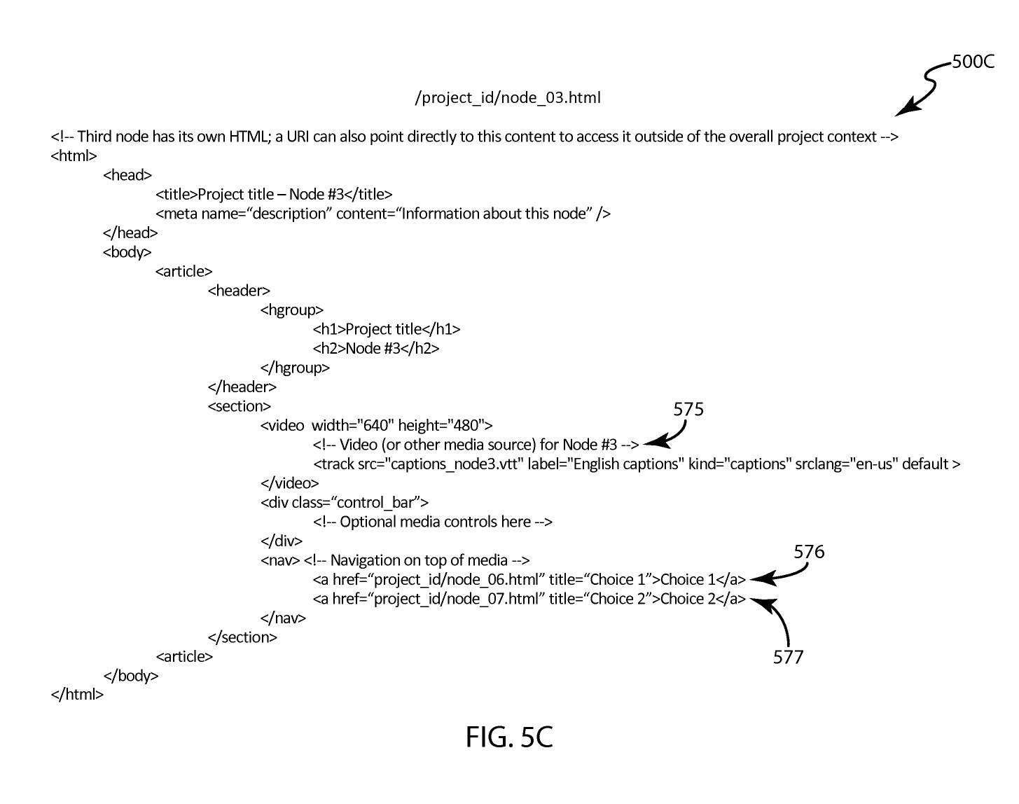

With reference now to FIG. 5A, a simplified listing 500A of HTML code for the first node 241 of FIG. 2. Although FIG. 5A (as well as other figures, such as FIGS. 4, 5B, and 5C) are described herein with reference to HTML, it will be appreciated that any type of web development code or language may be used, and that the disclosure is not limited to HTML code. Instead, HTML is used as one way to implement the present disclosure.

The simplified HTML code listing 500A in FIG. 5A may have an address 561 of /project_id/node_{—}01.html, as illustrated in FIG. 5A. The simplified listing 500A includes, among other things, a tag for the source 562 of the video or other media source for the first content segment corresponding to the first node 241. The listing 500A may also include a tag for closed caption data 564 corresponding to the first content segment as described below. Further, the listing 500A may also include tags for one or more media controls 566 (such as play, pause, stop, etc.), and tags for navigation 567. The navigation tags 567 include one or more links to other webpages corresponding to other nodes and associated content segments of the interactive media experience. For example, because the first node 241 includes options to proceed to the second and third nodes 242, 243 (see FIG. 2), the HTML listing corresponding to the webpage for the first node 241 may include a plurality of links 568, 569 that lead to the webpages associated with the second and third nodes 242, 243 and corresponding content segments. As illustrated in FIG. 5A, these embedded HTML links may be semantically labeled in that their structure and label within the HTML speak to the result of a participant clicking on each respective link. This semantic structure and labeling may allow an indexer 134 to quickly and efficiently understand not only the current node of the interactive media experience, but also the possible options that can be taken by a participant—such as links that can be followed to other content segments. The indexer 134 can then simulate a participant taking those options—such as by following the links—in order to characterize the various webpages corresponding to the nodes of the interactive media experience.

As mentioned above, in some examples, the HTML listing 500A for a webpage may include closed caption data. With reference to FIG. 5A, in some examples, the HTML may include a tag that references a separate closed caption data file 564. In other examples, the HTML may directly include text content derived from closed captioning of the respective content segment (whether the text content be keywords extracted from the closed captioning, the closed captioning itself, etc.). In either event, the tag or direct text content may be semantically labeled within the first webpage (and thus accessible and understandable by an indexer 134), but be hidden from a participant experiencing the content segment associated with the first node 241. Furthermore, in some examples, closed captioning data for a plurality of languages may be semantically labeled such that an indexer 134 can discern between the different language caption data, and select which set of caption data is appropriate for the indexer's 134 purposes.

The simplified HTML listings 500B, 500C in FIGS. 5B and 5C are generally similar to the simplified HTML listing 500A in FIG. 5A, except that the listings 500B, 500C in FIGS. 5B and 5C correspond to the webpages of the second and third nodes 242, 243, respectively. As such, the listing for the second node 242 in FIG. 5B includes a tag for the second content source 571, and links 572, 573, 574 to the fourth, fifth, and sixth nodes 244, 245, 246, and the listing for the third node 243 in FIG. 5C includes a tag for the third content source 575, and links 576, 577 to the sixth and seventh nodes 246, 247.

FIG. 6 illustrates a simplified screenshot 600 of a computer displaying a content segment of an interactive media experience. The screenshot 600 illustrates a web browser presenting the webpage corresponding to the first node 241 of the example plot structure illustrated in FIG. 2, as evidenced by the web page address shown in the address bar 682 of the web browser. The content segment 683 is a video subsection showing a character on a bike, and one or more media controls 684, 685 may be available. For example a pause/play button 684 may allow a participant to pause and restart the video subsection, and slider bar 685 may show the current position within the video subsection, optionally with a time indicated. Also illustrated in the screenshot 600 of FIG. 6 are two selectable buttons 687, 688 corresponding to the first and second choices at the branch point of the first node 241. The two buttons 687, 688 are shown overlaid on the content segment during presentation of the segment on the display device. Upon a participant clicking one of the two buttons 687, 688 (which may, for example, be hotspots), the web browser will transition from the first content segment 683, currently being displayed, to the content segment corresponding to the second or third nodes 242, 243, depending on which of the buttons 687, 688 the participant clicked. Specifically, if the participant clicks on the CHOICE 1 button 687, the HTML code underlying the webpage corresponding to the first node 241 and associated first content segment may cause the web browser to retrieve the HTML for the webpage corresponding to the second node 242 and its associated content segment. If the participant clicks on the CHOICE 2 button 688, the HTML code underlying the webpage corresponding to the first node 241 may cause the web browser to retrieve the HTML for the webpage corresponding to the third node 243 and its associated content segment. With reference back to FIG. 5A, the buttons 687, 688 correspond generally with the links 568, 569.

In some embodiments, the action of a participant clicking on one of the buttons 687, 688 may cause the web browser to immediately transition to the other content segment and node. In other embodiments, however, the web browser may selectively wait for a certain period of time before transitioning to the other content segment. In either type of embodiment, the web browser in conjunction with the server 110 may transition from providing the first content segment to either the second or third content segment to the participant in a “seamless” manner such that there is no gap or delay between providing the first content segment and the second or third content segment.

The apparatuses and associated methods in accordance with the present disclosure have been described with reference to particular embodiments thereof in order to illustrate the principles of operation. The above description is thus by way of illustration and not by way of limitation. Various modifications and alterations to the described embodiments will be apparent to those skilled in the art in view of the teachings herein. Those skilled in the art may, for example, be able to devise numerous systems, arrangements and methods which, although not explicitly shown or described herein, embody the principles described and are thus within the spirit and scope of this disclosure.

The concepts described herein have broad application. Accordingly, it is intended that all such alterations, variations, and modifications of the disclosed embodiments are within the scope of this disclosure.

In methodologies directly or indirectly set forth herein, various steps and operations are described in one possible order of operation, but those skilled in the art will recognize that the steps and operations may be rearranged, replaced, or eliminated without necessarily departing from the spirit and scope of the disclosed embodiments.

All relative and directional references herein are given by way of example to aid the reader's understanding of the particular embodiments described herein. They should not be read to be requirements or limitations as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

What is claimed is:

1. A server configured to provide internet content to a plurality of client computers, comprising:
a content storage module storing at least one interactive media experience, the interactive media experience including a plurality of content segments; and
a communications module configured to provide a plurality of respective webpages corresponding to respective ones of the plurality of content segments of the at least one interactive media experience, each respective webpage including one or more links to others of the plurality of respective webpages.

2. The server of claim 1, wherein the one or more links for each respective webpage are provided by the communications module in a manner to permit an indexer to crawl through all of the plurality of respective webpages by following the one or more links in each of the plurality of respective webpages.

3. The server of claim 1, wherein, upon selection of a first of the one or more links in a first of the plurality of webpages corresponding to a first of the plurality of content segments, the computer server is further configured to retrieve a second of the plurality of webpages and its corresponding second content segment of the interactive media experience.

4. The server of claim 3, wherein the computer server is further configured to transition from the first of the plurality of content segments to the second content segment in a manner that is seamless to a participant.

5. The server of claim 1, wherein at least one of the one or more links is an HTML link embedded in a respective webpage.

6. The server of claim 5, wherein the at least one link is semantically labeled within the respective webpage.

7. The server of claim 1, wherein the communications module is further configured to provide a main webpage defining a inline frame element, and the inline frame element is configured to display respective ones of the plurality of content segments of the at least one interactive media experience corresponding to respective ones of the plurality of respective webpages.

8. The server of claim 1, wherein each of the one or more links corresponds with a selectable button overlaid on the respective content segment during presentation of said content segment on a display device.

9. The server of claim 1, wherein the computer server is further configured to provide the respective webpage corresponding to any of the plurality of content segments when a participant enters a specific link to said respective webpage.

10. The server of claim 9, wherein the participant is a first participant, and the first participant receives the specific link from a second participant prior to entering the specific link.

11. The server of claim 1, wherein a first of the plurality of respective webpages corresponding to a first of the plurality of content segments comprises text content derived from closed captioning of the first content segment.

12. The server of claim 11, wherein the text content derived from closed captioning is semantically labeled within the first webpage but hidden from a participant experiencing the first content segment.

13. An apparatus, comprising:
a storage medium configured to store at least one interactive media experience defining a plurality of content segments, each of the plurality of content segments associated with a unique webpage address by which a participant may access respective ones of the plurality of content segments; and
a communications module configured to provide respective ones of the plurality of content segments to the participant via a plurality of respective webpages, each respective webpage of the plurality of respective webpages including at least one link to a unique webpage address associated with another of the plurality of content segments.

14. The apparatus of claim 13, wherein, upon selection of the at least one link by the participant, the communications module is further configured to provide a second of the plurality of content segments to the participant.

15. The apparatus of claim 13, wherein at least one of the respective webpages corresponding to a first of the plurality of content segments includes a plurality of links to unique webpage addresses associated with multiple ones of the plurality of content segments.

16. The apparatus of claim 13, wherein the first of the plurality of content segments includes a branch point, and each of the plurality of links correspond to possible options to be selected by the participant at the branch point.

17. The apparatus of claim 13, wherein the interactive media experience comprises an interactive video with a plurality of video subsections, and each of the plurality of video subsections corresponds with one of the plurality of content segments.

18. The apparatus of claim 13, wherein the interactive media experience comprises a slideshow of images, and each of the images corresponds with one of the plurality of content segments.

19. A method, comprising:
providing at least one server computer hosting an interactive media experience defined by a plurality of nodes, each of the plurality of nodes corresponding to a respective one of a plurality of content segments of the interactive media experience;
providing a first webpage including a first content segment of the plurality of content segments corresponding to a first node of the plurality of nodes; and
providing, within the first webpage, a link to a second node of the plurality of nodes.

20. The method of claim 19, wherein each of the plurality of nodes is accessible via a unique address.

21. The method of claim 20, wherein the unique address is a uniform resource identifier.

22. The method of claim 19, further comprising:
receiving a participant input selecting the link to the second node; and
providing a second content segment of the plurality of content segments corresponding to the second node.

23. The method of claim 22, wherein the second content segment is provided via a second webpage that includes the second content segment.

24. The method of claim 22, further comprising providing a persistent audio track contemporaneously with both the first and second content segments.
